(19) United States
(12) Patent Application Publication
(10) Pub. No.: US 2026/0279864 A1
(43) Pub. Date: Sep. 17, 2026

(54) Reforming Microchannel Reactor and Solid Oxide Fuel Cell Power Generation System

(71) Applicant: PetroChina Company Limited, Beijing (CN)

(72) Inventors: Xuerui Zhang, Beijing (CN); Haijun Zhong, Beijing (CN); Xiwen Song, Beijing (CN); Yue Wang, Beijing (CN); Xiaowei Hu, Beijing (CN); Qingxun Li, Beijing (CN); Haicheng Xiao, Beijing (CN); Yiran Wang, Beijing (CN)

(21) Appl. No.: 19/673,099

(22) Filed: May 11, 2026

Related U.S. Application Data
(63) Continuation of application No. PCT/CN2024/103116, filed on Jul. 2, 2024.

(30) Foreign Application Priority Data
Nov. 10, 2023 (CN) 202311498089.4

(51) Int. Cl. H01M 8/0612; H01M 8/04089; H01M 8/12; H01M 8/1246

(52) U.S. Cl. CPC H01M 8/0618; H01M 8/04089; H01M 8/1246; H01M 2008/1293

(57) ABSTRACT

The present disclosure provides a reforming microchannel reactor and a solid oxide fuel cell-containing power generation system. The reforming microchannel reactor comprises a housing and a plurality of plates arranged within the housing, and at least one combustion chamber, at least one heat exchange chamber and at least one reforming reaction chamber separated by the plates within the housing. The combustion chamber, the heat exchange chamber and the reforming reaction chamber are arranged alternately. Each heat exchange chamber is provided between a combustion chamber and a reforming reaction chamber. The combustion chamber and the heat exchange chamber are separated by a first plate. The heat exchange chamber and the reforming reaction chamber are separated by a second plate. Each of the first plate and the second plate comprises a ceramic-metal composite substrate and a combustion catalyst layer supported on at least one surface of the ceramic-metal composite substrate.

### CROSS-REFERENCE TO RELATED APPLICATIONS

This application is a continuation of International Application No. PCT/CN2024/103116, filed on Jul. 2, 2024, which claims priority to Chinese Patent Application No. CN 202311498089.4, filed on Nov. 10, 2023, both of which are hereby incorporated by reference in their entireties.

### TECHNICAL FIELD

The present disclosure belongs to the technical field of new energy development and utilization and energy conversion, and particularly relates to a reforming microchannel reactor and a solid oxide fuel cell-containing power generation system.

### BACKGROUND OF ART

The solid oxide fuel cell-containing (SOFC) power generation system is an efficient energy conversion device that can convert chemical energy stored in various gases or liquid fuels such as methane, hydrogen, ethanol and gasoline into electrical energy and it is not limited by Carnot cycle. Compared with the existing traditional gas power plants, this system has higher energy efficiency, power generation efficiency up to 60% or more, and cogeneration efficiency up to 90% or more, which has lower environmental impact and is considered as one of the important technologies for realizing energy saving and emission reduction in the future. In particular, the oil and gas industry developed SOFC has many advantages such as good gas source basis, many application scenarios, and integrated development of oil and gas services. In the oil and gas production process, large amounts of cheap complex natural gas resources are generated, which can be used as high-quality fuels for SOFC power generation.

However, natural gas resources generated in the oil and gas production process has a complex composition, in which main components are hydrogen, methane and light hydrocarbon components. Thus, if they directly enter the SOFC pile as raw materials, it is easy to cause problems such as carbon deposition, which seriously affects the service life of the catalyst and the pile and reduces the power generation efficiency. It is usually necessary to be assembled with a light hydrocarbon component recovery device or a corresponding external reforming device for hydrocarbons to convert them into a syngas, which then enters the pile system. Hydrocarbon reforming techniques comprise dry reforming, self-reforming, steam reforming, and the like. Among them, the steam reforming technology is currently the most mature method that has been industrialized. However, when applying this technology to SOFCs for oil and gas resource development, the following primary issues arise:

(1) the steam reforming reaction for a gas represented by methane is a strong endothermic reaction; meanwhile, a predetermined pressure (3-5 MPa) is required to increase the reaction rate, resulting in high equipment cost and high energy consumption; (2) the reforming of hydrocarbon raw materials containing high-carbon hydrocarbon components generally involves a mode in which the pre-reforming and reforming reactors are usually connected in series with different catalysts and reaction conditions, which increases the processing difficulty and investment operation cost; (3) the heat exchange efficiency of the high-temperature flue gas with the reformer is low, and thus a reforming device with a large heat exchange area is required to achieve the expected heat exchange effect, resulting in a huge system, which is not conducive to the integration of the power generation system, and is prone to structural interference with other components in the system; and (4) the system has a large weight, which is not conducive to transportation and installation. The aforementioned issues have collectively hindered the further promotion and application of SOFC power generation systems. How to effectively process complex natural gas resources in the actual application process of SOFC becomes an urgent problem to be solved by those skilled in the art.

Microchannel reactor technology has been widely used in many fields such as biological analysis, medical diagnosis, and chemical synthesis, and microstructure units serve as the core to perform chemical reactions in micron or sub-micron confined spaces. By reducing the dispersion scale of the system, enhancing mixing and transfer, it has many advantages such as efficient mixing ability, good mass and heat transfer characteristics, and highly controllable reaction process. The steam reforming process for methane involves gas combustion to supply heat for the reforming reaction, which has low heat transfer efficiency, high energy consumption, large equipment, complex structure, and high material requirements. Moreover, the catalyst effectiveness factor is low and the reaction rate is slow due to heat transfer limitations. The microchannel reactor can utilize the characteristics of its high specific surface area to efficiently couple endothermic and exothermic reactions in a small scale space, thereby enhancing the transfer of heat and mass. Moreover, the microchannel reactor can be amplified in parallel, which not only has no amplification effect, but also can meet the requirements of different hydrogen production scales. However, there are still few applications of microchannel reactors in solid oxide fuel cells. To date, there are still great challenges in the use and promotion of microchannel reactors, including the following facts: under high temperature conditions, the catalyst is easy to sinter, resulting in lager bulk material, and the fine pore structure of the microchannel reactor is easily blocked by the solid catalyst to be failed. Meanwhile, the enlargement of the microchannel reactor often requires increasing the diameter of the microchannel, that is, the so-called size enlargement. However, there is an obvious amplification effect in size amplification, that is, an increase in the diameter of the channel leads to a decrease in the specific surface, a larger average distance between fluids, and a non-linear decrease in the performances of mixing, mass transfer and heat transfer. The above problems limit their large-scale industrial applications.

To sum up, there remains a need to develop technical solutions for integrating reforming microchannel reactors into SOFC power generation systems while effectively preventing blockages during high-temperature operation. This would enable efficient reforming of complex refinery tail gas streams, enhance reforming and heat exchange efficiency in SOFC power generation systems, reduce the reaction energy consumption, and improve the overall integration of SOFC power generation systems.

### SUMMARY

An object of the present disclosure is to provide a technical solution, in which a microchannel reactor for producing syngas via a reforming reaction is integrated into a SOFC power generation system while effectively preventing blockages in the microchannel reactor during high-temperature operation. This would enable efficient reforming of complex refinery tail gas streams, enhance reforming and heat exchange efficiency in the SOFC power generation system, reduce the reaction energy consumption, and improve the overall integration of the SOFC power generation system. In order to achieve the above object, the present disclosure provides the following two technical solutions:

In a first aspect, the present disclosure provides a reforming microchannel reactor, comprising a housing and a plurality of plates arranged within the housing, and at least one combustion chamber, at least one heat exchange chamber and at least one reforming reaction chamber separated by the plates within the housing;
wherein the combustion chamber, the heat exchange chamber and the reforming reaction chamber are arranged alternately, and each heat exchange chamber is provided between a combustion chamber and a reforming reaction chamber;
wherein the plurality of plates comprise a first plate and a second plate; the combustion chamber and the heat exchange chamber are separated by the first plate, and the heat exchange chamber and the reforming reaction chamber are separated by the second plate; the first plate comprises a ceramic-metal composite substrate and a combustion catalyst layer supported on at least one surface of the ceramic-metal composite substrate, and the combustion catalyst layer is located on the side facing the combustion chamber, wherein the combustion catalyst in the combustion catalyst layer is a monoatomic metal-based catalyst; and the second plate comprises a ceramic-metal composite substrate and a reforming catalyst layer supported on at least one surface of the ceramic-metal composite substrate, and the reforming catalyst layer is located on the side facing the reforming reaction chamber, wherein the reforming catalyst in the reforming catalyst layer is a monoatomic metal-based catalyst.

In the reforming microchannel reactor, the reforming reaction chamber is used to perform a reforming reaction, the combustion chamber is used to perform a catalytic fuel combustion reaction to supply heat for the reforming reaction in the reforming reaction chamber, and the heat exchange chamber is used as a coolant flow channel to transfer the heat generated by the fuel combustion to the reforming reaction chamber.

The reforming microchannel reactor provided by the first aspect of the present disclosure adopts a combination of the combustion chamber, the heat exchange chamber and the reforming reaction chamber, which effectively realizes the control of the heating process of supplying the heat generated by the combustion chamber to the reforming reaction chamber, and avoids the excessive high temperature in the reforming reaction chamber. At the same time, the catalysts in the combustion chamber and the reforming reaction chamber are monoatomic metal-based catalysts and coated on the ceramic surface in the ceramic-metal composite substrate, thereby effectively avoiding the agglomeration and shedding of the catalysts in the microchannel reactor, so that the problem that the microchannel reactor is prone to blockage during high-temperature operation is solved.

According to a preferred embodiment of the first aspect, within the housing, when a combustion chamber serves as the outermost chamber adjacent to the housing, a first plate is provided between the combustion chamber and the housing, wherein the combustion catalyst layer is located on the side of facing combustion chamber.

According to a preferred embodiment of the first aspect, within the housing, when a reforming reaction chamber serves as the outermost chamber adjacent to the housing, a second plate is provided between the reforming reaction chamber and the housing, wherein the reforming catalyst layer is located on the side facing the reforming reaction chamber.

According to a preferred embodiment of the first aspect, the inner side of the housing is provided with a thermal insulation layer.

According to a preferred embodiment of the first aspect, the reforming microchannel reactor is a flat plate microchannel reactor, and the combustion chamber, the heat exchange chamber and the reforming reaction chamber are arranged within the housing of the reforming microchannel reactor along the thickness direction of the reforming microchannel reactor.

Further, a reforming reaction chamber, a heat exchange chamber, a combustion chamber, a heat exchange chamber, a reforming reaction chamber, a heat exchange chamber, a combustion chamber, a heat exchange chamber, a reforming reaction chamber, a heat exchange chamber, and a combustion chamber are sequentially arranged within the housing of the reforming microchannel reactor along the thickness direction of the reforming microchannel reactor.

Further, the reforming reaction chamber has a thickness of not greater than 1 mm; furthermore, the reforming reaction chamber has a thickness of 10-1000 μm; in a specific embodiment, the reforming reaction chamber has a thickness of 0.5 mm. Maintaining the thickness of the reforming reaction chamber at 1 mm or less enables a substantial heat transfer surface area within the chamber. This facilitates prompt heat transfer, ensuring the reforming reaction chamber is consistently maintained at elevated temperatures, so that the reaction can be completed within a millisecond-level residence time.

Further, the heat exchange chamber has a thickness of not greater than 1 mm; furthermore, the heat exchange chamber has a thickness of 10-1000 μm; in a specific embodiment, the heat exchange chamber has a thickness of 0.5 mm.

Further, the combustion chamber has a thickness of not greater than 1 mm; furthermore, the combustion chamber has a thickness of 10-1000 μm; in a specific embodiment, the combustion chamber has a thickness of 0.5 mm.

Further, the reforming microchannel reactor is operated in a T-shaped, cross-shaped or coaxial ring-tube feeding mode.

Further, the configuration of feed and discharge ports for each chamber of the reforming microchannel reactor enables a single-pass cross-flow movement of fluid through each chamber of the reactor. The design of a planar single-pass cross-flow arrangement in the three chambers, that is the combustion chamber, heat exchange chamber, and reforming reaction chamber, facilitates efficient heat transfer while enabling precise control of the reforming reaction temperature, and allows for tailored temperature regulation for different components.

Further, the configuration of feed and discharge ports for each chamber of the reforming microchannel reactor enables a cross-shaped cross-flow movement of fluid through each chamber of the reactor. For example, the direction of fluid flow in the chambers arranged in the thickness direction of the reforming microchannel reactor within the housing of the reactor alternates between the length direction and width direction of the reactor. That is, assuming that the chambers within the housing of the reforming microchannel reactor are sequentially named as a first chamber, a second chamber . . . an N-th chamber, along the thickness direction of the reforming microchannel reactor, as the fluid in the i-th chamber flows along the length direction of the reforming microchannel reactor, the fluid in the (i+1)-th chamber flows along the width direction of the reforming microchannel reactor, the fluid in the (i+2)-th chamber flows along the length direction of the reforming microchannel reactor, the fluid in the (i+3)-th chamber flows along the width direction of the reforming microchannel reactor, and so forth.

According to a preferred embodiment of the first aspect, the ceramic-metal composite substrate of the first plate is composed of a metal plate core and a ceramic shell laminated on the surface of the metal plate; further, the metal plate core of the ceramic-metal composite substrate of the first plate has a thickness of not greater than 2 cm, and the ceramic shell laminated on the surface of the metal plate has a thickness of not greater than 50 μm.

According to a preferred embodiment of the first aspect, the ceramic-metal composite substrate of the second plate is composed of a metal plate core and a ceramic shell laminated on the surface of the metal plate; further, the metal plate core of the ceramic-metal composite substrate of the second plate has a thickness of not greater than 2 cm, and the ceramic shell laminated on the surface of the metal plate has a thickness of not greater than 50 μm.

According to a preferred embodiment of the first aspect, the combustion catalyst is a Pt-based catalyst.

Further, the combustion catalyst is a Pt/Al₂O₃ catalyst.

Furthermore, based on 100% by mass of Al₂O₃, the loading amount of Pt is not greater than 4%.

According to a preferred embodiment of the first aspect, the reforming catalyst is a Rh-based catalyst;

Further, the reforming catalyst is a Rh/Al₂O₃ catalyst.

Even further, based on 100% by mass of Al₂O₃, the loading amount of Rh is not greater than 4%.

According to a preferred embodiment of the first aspect, the first plate can be prepared by:
spraying alumina onto a metal plate by thermal spraying to form a ceramic-metal composite substrate; pretreating the ceramic-metal composite substrate by a process including cutting, cleaning, ultrasonic treatment, and the like; and coating the surface of the pretreated ceramic-metal composite substrate with alumina sol to obtain a first substrate;
weighing and mixing an amount of an active metal precursor salt corresponding to the combustion catalyst (when the combustion catalyst is a Pt-based catalyst, platinum acetate is selected as an active metal precursor acetate), an organic ligand and an organic solvent to obtain a first solution; and impregnating at least one surface of the first substrate with the first solution, drying and roasting under a protective atmosphere to obtain the first plate.

Further, the active metal precursor salt comprises one or more of a nitrate, sulfate, chloride and acetate of the active metal.

Further, the organic ligand comprises at least one of phenanthroline, 2,2-bipyridine, melamine and phenylalanine.

Further, the organic solvent comprises at least one of dimethyl sulfoxide and ethanol.

Further, in the first solution, the molar ratio of the active metal precursor salt to the organic ligand is 1:5-1:20.

Further, in the first solution, based on the total volume of the first solution, the molar concentration of the active metal precursor salt is not greater than 0.2 mol·L⁻¹.

Further, in the first solution, based on the total volume of the first solution, the molar concentration of the organic ligand is not greater than 4 mol·L⁻¹.

Further, the process of spraying alumina onto the metal plate by thermal spraying to form the ceramic-metal composite substrate is carried out under conditions of a combustion-supporting gas which is oxygen in a gas pressure of 0.3-1.0 MPa, a combustion gas which is acetylene in a gas pressure of 0.05-0.3 MPa, an auxiliary gas which is compressed air in a gas pressure of 0.3-1.0 MPa, a powder feeding rate of 10-100 g/min, a spraying distance of 50-200 mm, a flame gun moving speed of 100-1200 mm/s, and a coating spraying number of 1-30.

Further, the protective atmosphere comprises an argon atmosphere and/or a nitrogen atmosphere.

Further, the roasting is performed at a roasting temperature of 300-800° C. for 1-5 hours.

Further, the ramp rate rising to the roasting temperature during the roasting process is 2-10° C./min.

Further, the drying is a drying process by heating. In a specific embodiment, the drying comprises heating in a water bath at 60° C. for 4 h, followed by standing in an oven at 80° C. for 12 h.

According to a preferred embodiment of the first aspect, the second plate can be prepared by:
spraying alumina onto a metal plate by thermal spraying to form a ceramic-metal composite substrate; pretreating the ceramic-metal composite substrate by a process including cutting, cleaning, ultrasonic treatment, and the like; and coating the surface of the pretreated ceramic-metal composite substrate with alumina sol to obtain a second substrate;
weighing and mixing an amount of an active metal precursor salt corresponding to the combustion catalyst (when the combustion catalyst is a Rh-based catalyst, rhodium acetate is selected as an active metal precursor acetate), an organic ligand and an organic solvent to obtain a second solution; and
impregnating at least one surface of the second substrate with the second solution, drying and roasting under a protective atmosphere to obtain the second plate.

Further, the active metal precursor salt comprises one or more of active metal precursor salt.

Further, the organic ligand comprises at least one of phenanthroline, 2,2-bipyridine, melamine and phenylalanine.

Further, the organic solvent comprises at least one of dimethyl sulfoxide and ethanol.

Further, in the second solution, the molar ratio of the active metal precursor salt to the organic ligand is 1:5-1:20.

Further, in the second solution, based on the total volume of the second solution, the molar concentration of the active metal precursor salt is not greater than 0.2 mol·L⁻¹.

Further, in the second solution, based on the total volume of the second solution, the molar concentration of the organic ligand is not greater than 4 mol·L⁻¹.

Further, the process of spraying alumina onto the metal plate by thermal spraying to form the ceramic-metal composite substrate is carried out under conditions of a combustion-supporting gas which is oxygen in a gas pressure of 0.3-1.0 MPa, a combustion gas which is acetylene in a gas pressure of 0.05-0.3 MPa, an auxiliary gas which is compressed air in a gas pressure of 0.3-1.0 MPa, a powder feeding rate of 10-100 g/min, a spraying distance of 50-200 mm, a flame gun moving speed of 100-1200 mm/s, and a coating spraying number of 1-30.

Further, the protective atmosphere comprises an argon atmosphere and/or a nitrogen atmosphere.

Further, the roasting is performed at a roasting temperature of 300-800° C. for 1-5 hours.

Further, the ramp rate rising to the roasting temperature during the roasting process is 2-10° C./min.

Further, the drying is a drying process by heating. In a specific embodiment, the drying comprises heating in a water bath at 60° C. for 4 h, followed by standing in an oven at 80° C. for 12 h.

According to a preferred embodiment of the first aspect, the reforming microchannel reactor further comprises a coolant located within the heat exchange chamber, wherein the coolant is a molten salt.

Further, the coolant is a molten salt selected from LiF—NaF—KF, KCl—MgCl₂ or NaNO₃—NaNO₂—KNO₃.

Even further, the coolant is a KCl—MgCl₂ molten salt.

The molten salt, especially selected from LiF—NaF—KF, KCl—MgCl₂ or NaNO₃—NaNO₂—KNO₃, has excellent chemical and heat transfer performance under high temperature conditions, wherein the KCl—MgCl₂ molten salt has better performance.

According to a preferred embodiment of the first aspect, the reforming reaction feed port and the reforming reaction discharge port of the reforming microchannel reactor are provided with a temperature detector (for example, a thermocouple-type temperature detector) for detecting the temperature of the fluid entering and leaving the reforming reaction chamber, which is helpful to evaluate the temperature within the reforming reaction chamber.

According to a preferred embodiment of the first aspect, the heat exchange chamber is externally connected with a temperature and flow control device for regulating the flow of the coolant in the heat exchange chamber, thereby regulating the temperature of the reforming reaction chamber. For example, the temperature and flow control device comprises a temperature feedback module, which determines the temperature in the reforming reaction chamber. Then the flow of the coolant is adjusted by an automatic control program, thereby regulating the temperature of the heat exchange chamber.

According to a preferred embodiment of the first aspect, a temperature sensor is provided in the heat exchange chamber.

In a second aspect, the present disclosure provides a solid oxide fuel cell-containing power generation system, comprising:
a unit for supplying materials to be reformed, a deionized water supply unit, an air supply unit, a fuel supply unit, a microchannel reactor unit for reforming and producing syngas, and a solid oxide fuel cell; the microchannel reactor unit for reforming and producing syngas comprises at least one reforming microchannel reactor provided by the first aspect of the present disclosure;
wherein the unit for supplying materials to be reformed, the deionized water supply unit, the air supply unit, the fuel supply unit, the microchannel reactor unit for reforming and producing syngas and the solid oxide fuel cell are connected to enable the unit for supplying materials to be reformed to supply the materials to be reformed required for the reforming reaction to the microchannel reactor unit for reforming and producing syngas, enable the deionized water supply unit to supply the steam required for the reforming reaction to the microchannel reactor unit for reforming and producing syngas, enable the fuel supply unit to supply the fuel required for the catalytic combustion reaction to the microchannel reactor unit for reforming and producing syngas, enable the air supply unit to supply air to the cathode of the solid oxide fuel cell, and enable the syngas produced by the reforming reaction in the microchannel reactor unit for reforming and producing syngas to be supplied to the anode of the solid oxide fuel cell (that is, the reforming reaction discharge port for the reforming reaction in the microchannel reactor unit for reforming and producing syngas is connected to the anode gas inlet of the solid oxide fuel cell).

The solid oxide fuel cell-containing power generation system provided by the second aspect of the present disclosure adopts the special reforming microchannel reactor provided by the first aspect of the present disclosure, which allows the microchannel reactor unit for reforming and producing syngas to be integrated into a SOFC power generation system while effectively preventing blockages during high-temperature operation, thereby enabling efficient reforming of complex refinery tail gas streams, enhancing reforming and heat exchange efficiency in the SOFC power generation system, reducing the reaction energy consumption, and improving the overall integration of the SOFC power generation system.

According to a preferred embodiment of the second aspect, the system further comprises: a heat exchange unit comprising a first heat exchanger, a second heat exchanger, a third heat exchanger, a fourth heat exchanger, a fifth heat exchanger and a sixth heat exchanger;
wherein the first fluid inlet of the first heat exchanger is connected to the outlet of the unit for supplying materials to be reformed, the first fluid outlet of the first heat exchanger is connected to the first fluid inlet of the fourth heat exchanger, and the first fluid outlet of the fourth heat exchanger is connected to the reforming reaction feed port of the microchannel reactor unit for reforming and producing syngas;
the first fluid inlet of the second heat exchanger is connected to the outlet of the deionized water supply unit, and the first fluid outlet of the second heat exchanger is connected to the reforming reaction feed port of the microchannel reactor unit for reforming and producing syngas;
the first fluid inlet of the third heat exchanger is connected to the outlet of the air supply unit, the first fluid outlet of the third heat exchanger is connected to the first fluid inlet of the fifth heat exchanger, and the first fluid outlet of the fifth heat exchanger is connected to the cathode gas inlet of the solid oxide fuel cell;
the first fluid inlet of the sixth heat exchanger is connected with the outlet of the fuel supply unit, and the first fluid outlet of the sixth heat exchanger is connected with the catalytic combustion reaction feed port of the microchannel reactor unit for reforming and producing syngas;
the second fluid inlet of the third heat exchanger is connected to the anode end outlet of the solid oxide fuel cell, the second fluid outlet of the third heat exchanger is connected to the second fluid inlet of the second heat exchanger, and the second fluid outlet of the second heat exchanger is connected to the second fluid inlet of the first heat exchanger;
the catalytic combustion reaction discharge port of the microchannel reactor unit for reforming and producing syngas is connected to the second fluid inlet of the fourth heat exchanger, the second fluid outlet of the fourth heat exchanger is connected to the second fluid inlet of the sixth heat exchanger, and the cathode end outlet of the solid oxide fuel cell is connected to the second fluid inlet of the fifth heat exchanger.

Further, the second fluid outlet of the first heat exchanger is connected to the second fluid inlet of the sixth heat exchanger; even further, a gas-water separator is provided on a connecting pipeline between the second fluid outlet of the first heat exchanger and the second fluid inlet of the sixth heat exchanger to remove water in the fluid.

Further, the second fluid outlet of the first heat exchanger is connected to the catalytic combustion reaction feed port of the microchannel reactor unit for reforming and producing syngas.

According to a preferred embodiment of the second aspect, the microchannel reactor unit for reforming and producing syngas comprises at least two reforming microchannel reactors provided by the first aspect of the present disclosure, which are sequentially connected in series, wherein the reforming reaction discharge port of the i-th reforming microchannel reactor is connected to the reforming reaction feed port of the (i+1)-th reforming microchannel reactor; the coolant feed port of the i-th reforming microchannel reactor is connected to the coolant discharge port of the (i+1)-th reforming microchannel reactor; the catalytic combustion reaction feed port of the i-th reforming microchannel reactor is connected to the catalytic combustion reaction discharge port of the (i+1)-th reforming microchannel reactor; the catalytic combustion reaction discharge port of the first reforming microchannel reactor serves as the catalytic combustion reaction discharge port of the microchannel reactor unit for reforming and producing syngas; the catalytic combustion reaction feed port of the last reforming microchannel reactor serves as the catalytic combustion reaction feed port of the microchannel reactor unit for reforming and producing syngas; the reforming reaction discharge port of the last reforming microchannel reactor serves as the reforming reaction discharge port of the microchannel reactor unit for reforming and producing syngas; the reforming reaction feed port of the first reforming microchannel reactor serves as the reforming reaction feed port of the microchannel reactor unit for reforming and producing syngas; the coolant discharge port of the first reforming microchannel reactor serves as the coolant discharge port of the microchannel reactor unit for reforming and producing syngas; and the coolant discharge port of the last reforming microchannel reactor serves as the coolant discharge port of the microchannel reactor unit for reforming and producing syngas.

According to a preferred embodiment of the second aspect, the unit for supplying materials to be reformed comprises a desulfurizer, wherein the inlet of the desulfurizer is connected to a source of the material to be reformed, and the outlet of the desulfurizer serves as the outlet of the unit for supplying materials to be reformed.

According to a preferred embodiment of the second aspect, the deionized water supply unit comprises a water pump, wherein the inlet of the water pump is connected to a source of deionized water, and the outlet of the water pump serves as the outlet of the deionized water supply unit.

According to a preferred embodiment of the second aspect, the air supply unit comprises an air compressor, wherein the inlet of the air compressor is connected to the source of air, and the outlet of the air compressor serves as the outlet of the air supply unit.

The technical solution provided by the present disclosure has the following beneficial effects as compared with the prior art:
(1) The reforming microchannel reactor provided by the present disclosure adopts the combination of the combustion chamber, the heat exchange chamber and the reforming reaction chamber. At the same time, the catalysts in the combustion chamber and the reforming reaction chamber are monoatomic metal-based catalysts and coated on the ceramic surface in the ceramic-metal composite substrate, thereby effectively avoiding the agglomeration and shedding of the catalysts in the microchannel reactor, so as to solve the problem that the microchannel reactor is prone to blockage during high-temperature operation.
(2) The microchannel reactor provided by the present disclosure has high energy conversion efficiency and good heat and mass transfer performance, which significantly improves the heat transfer and reaction efficiency of the reforming reaction, and realizes efficient and rapid reforming.
(3) The microchannel reactor provided by the present disclosure is designed to have a three-channel including a combustion chamber, a heat exchange chamber and a reforming reaction chamber, which can effectively regulate the temperature of the reforming reaction while achieving efficient heat transfer reaction, and is conducive to reforming treatment of raw materials having various components.
(4) The reforming microchannel reactor provided by the present disclosure has variability in reactants and products. By regulating the type of the coated catalyst layer and the flow rate of the coolant, the reforming microchannel reactor provided by the present disclosure can be resistant to different types of reaction raw materials, methane and other light hydrocarbon components in complex gas resources. At the same time, the reforming microchannel reactor can achieve both efficient production of hydrogen and efficient production of syngas. In addition, the reforming microchannel reactor provided by the present disclosure can withstand a certain reaction pressure, which will further improve the reaction efficiency, and its use in the solid oxide fuel cell-containing power generation system can widen the application range of the SOFC system.
(5) The solid oxide fuel cell-containing power generation system provided by the present disclosure performs the reforming reaction by using the microchannel reactor provided by the present disclosure. The microchannel reactor has many advantages such as low volume, light weight, high strength, high heat transfer efficiency, low leakage rate, solder free, strong corrosion resistance, and high weld reliability. At the same time, the microchannel reactor is resistant to high pressure, high temperature and corrosion, and has a long lifetime. The use of the microchannel reactor effectively improves the integration of the solid oxide fuel cell-containing power generation system, which facilitates to simplify the solid oxide fuel cell-containing power generation system, reduce the system weight, and reduce the cost of the system.
(6) The solid oxide fuel cell-containing power generation system provided by the present disclosure uses the microchannel reactor provided by the present disclosure to realize the amplification of the supply scale of the feed gas without a step-by-step amplification device, so that the solid oxide fuel cell-containing power generation system provided by the present disclosure can match power generation application scenarios of various scales. It can be used in both large-scale power generation devices such as data center power supply and refinery power supply, and small-scale stable power supply systems such as aerospace and vehicle power systems.
(7) The solid oxide fuel cell-containing power generation system provided by the present disclosure has flexibility and variability, and can achieve flexible matching with various energy supply devices. Subsequently, it can not only be connected in series with the SOFC power generation system, but also be connected in series and with PEMFC or MCFC in a flexible matching manner, and used as a fuel cell vehicle power device and the like.

### BRIEF DESCRIPTION OF DRAWINGS

FIG. 1 is a schematic structural diagram of the solid oxide fuel cell-containing power generation system according to Example 1.

FIG. 2 is a schematic structural diagram of the microchannel reactor unit for reforming and producing syngas according to Example 1.

FIG. 3 is a schematic structural diagram of the first plate according to Example 1.

### DESCRIPTION OF EMBODIMENTS

In order to have a clearer understanding of the technical features, purposes and beneficial effects of the present disclosure, the technical solutions of the present disclosure will now be described below in details, but it should not be construed as limiting the implementable scope of the present disclosure.

### Example 1

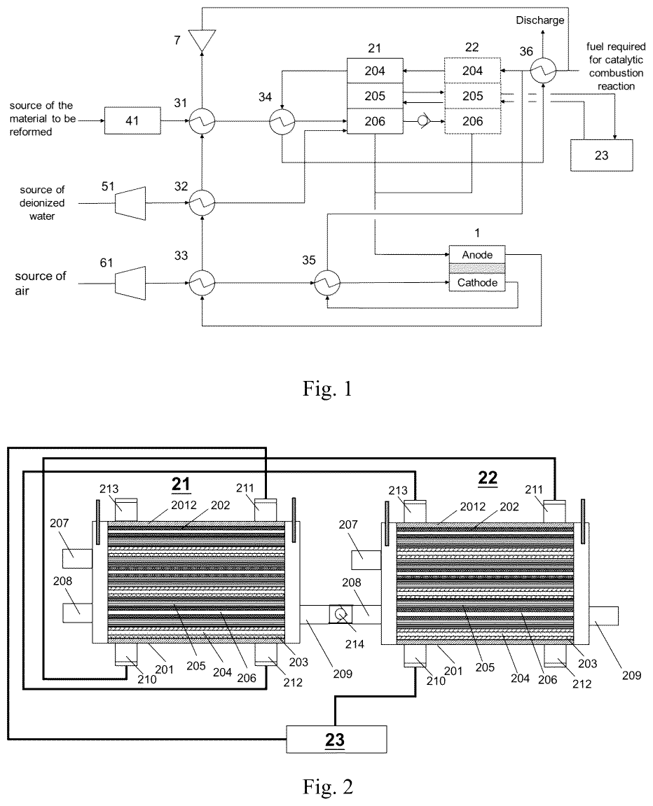

This example provides a solid oxide fuel cell-containing power generation system. As shown in FIG. 1, the system comprises a unit for supplying materials to be reformed, a deionized water supply unit, an air supply unit, a fuel supply unit, a heat exchange unit, a microchannel reactor unit for reforming and producing syngas and a solid oxide fuel cell 1.

As shown in FIG. 2, the microchannel reactor unit for reforming and producing syngas comprises a first reforming microchannel reactor 21 and a second reforming microchannel reactor 22 connected in series. The first reforming microchannel reactor 21 and the second reforming microchannel reactor 22 are both flat plate-type microchannel reactors, and each of them comprises a housing 201, a first plate 202 and a second plate 203 arranged within the housing, and a combustion chamber 204, a heat exchange chamber 205 and a reforming reaction chamber 206 separated by the first plate 202 and the second plate 203 within the housing 201, wherein the reforming reaction chamber 206 is configured to perform a reforming reaction, the combustion chamber 204 is configured to perform a fuel catalytic combustion reaction to supply heat for the reforming reaction in the reforming reaction chamber 206, and the heat exchange chamber 205 serves as a coolant flow channel to transfer the heat generated by fuel combustion to the reforming reaction chamber 206; wherein a reforming reaction chamber 206, a heat exchange chamber 205, a combustion chamber 204, a heat exchange chamber 205, a reforming reaction chamber 206, a heat exchange chamber 205, a combustion chamber 204, a heat exchange chamber 205, a reforming reaction chamber 206, a heat exchange chamber 205, and a combustion chamber 204 are sequentially arranged along the thickness direction of the reforming microchannel reactor. The thickness of the reforming reaction chamber is 0.5 mm, the thickness of the combustion chamber is 0.5 mm, and the thickness of the heat exchange chamber is 0.5 mm. The feed ports and the discharge ports within each chamber of the reforming microchannel reactor are configured to enable a single-pass cross-flow movement of fluid in each chamber of the reactor. Specifically, the direction of fluid flow in the combustion chamber 204, the heat exchange chamber 205 and the reforming reaction chamber 206 arranged in the thickness direction of the reforming microchannel reactor within the housing 201 alternates between the length direction and width direction of the reactor. The combustion chamber 204 and the heat exchange chamber 205 are separated by a first plate 202, and the heat exchange chamber 205 and the reforming reaction chamber 206 are separated by a second plate 203. A first plate 202 is provided between the outermost combustion chamber 204 adjacent to the housing 201 and the housing 201, and the combustion catalyst layer is located on the side facing the combustion chamber 204. A second plate 203 is provided between the outermost reforming reaction chamber 206 adjacent to the housing 201 and the housing 201, and the reforming catalyst layer is located on the side facing the reforming reaction chamber 206.

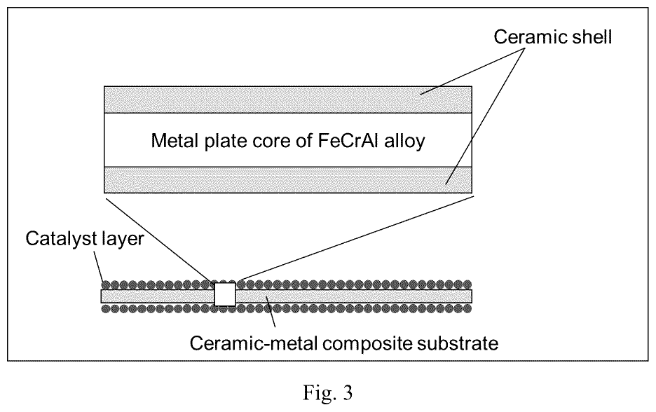

The first plate 202 comprises a ceramic-metal composite substrate and a combustion catalyst layer supported on the surface of the ceramic-metal composite substrate (as shown in FIG. 3), and the combustion catalyst in the combustion catalyst layer is a monoatomic metal-based catalyst, specifically a Pt/Al₂O₃ catalyst, with a loading amount of 4%. The second plate 203 comprises a ceramic-metal composite substrate and a reforming catalyst layer supported on the surface of the ceramic-metal composite substrate, and the reforming catalyst of the reforming catalyst layer is a monoatomic metal-based catalyst, specifically a Rh/Al₂O₃ catalyst, with a loading amount of 4%. The ceramic-metal composite substrate of the first plate 202 and the ceramic-metal composite substrate of the second plate 203 are both composed of a FeCrAl alloy metal plate core and a ceramic shell laminated on the surface of the metal plate. The thickness of the metal plate core of the ceramic-metal composite substrate of the first plate is 0.7 mm, and the thickness of the ceramic shell laminated on the surface of the metal plate is 10 μm. The thickness of the metal plate core of the ceramic-metal composite substrate of the second plate is 0.7 mm, and the thickness of the ceramic shell laminated on the surface of the metal plate is 10 μm. The first plate 202 can be prepared by a process of spraying alumina onto a metal plate by thermal spraying to form a ceramic-metal composite substrate, under conditions of a combustion-supporting gas which is oxygen in a gas pressure of 0.3-1.0 MPa, a combustion gas which is ethylene in a gas pressure of 0.05-0.3 MPa, an auxiliary gas which is compressed air in a gas pressure of 0.3-1.0 MPa, a powder feeding rate of 10-100 g/min, a spraying distance of 50-200 mm, a flame gun moving speed of 100-1200 mm/s, and a coating spraying number of 1-30; pretreating the ceramic-metal composite substrate, including cutting, cleaning, ultrasonic treatment, and the like; coating the surface of the pretreated ceramic-metal composite substrate with alumina sol to have a thickness of 10 μm so as to obtain a first substrate; weighing and mixing 0.2 mmol of platinum acetate, 1 mmol of phenanthroline and 100 ml of ethanol to obtain a first solution; immersing the first substrate in the first solution, heating in a water bath at 60° C. for 4 h, followed by standing in an oven at 80° C. for 12 h, and then heating to 750° C. under an argon atmosphere at 5° C./min and roasting at 750° C. for 4 h, followed by naturally cooling to room temperature, to obtain the first plate. The second plate 203 can be prepared by a process of spraying alumina onto a metal plate by thermal spraying to form a ceramic-metal composite substrate under conditions of a combustion-supporting gas which is oxygen in a gas pressure of 0.3-1.0 MPa, a combustion gas which is ethylene in a gas pressure of 0.05-0.3 MPa, an auxiliary gas which is compressed air in a gas pressure of 0.3-1.0 MPa, a powder feeding rate of 10-100 g/min, a spraying distance of 50-200 mm, a flame gun moving speed of 100-1200 mm/s, and a coating spraying number of 1-30; pretreating the ceramic-metal composite substrate, including cutting, cleaning, ultrasonic treatment, and the like; coating the surface of the pretreated ceramic-metal composite substrate with alumina sol to have a thickness of 10 μm so as to obtain a second substrate; weighing and mixing 0.2 mmol of rhodium acetate, 1 mmol of phenanthroline and 100 ml of ethanol to obtain a second solution; immersing the second substrate in the second solution, heating in a water bath at 60° C. for 4 h, followed by standing in an oven at 80° C. for 12 h, and then heating to 750° C. under an argon atmosphere at 5° C./min and roasting at 750° C. for 4 h, followed by naturally cooling to room temperature, to obtain the second plate.

Each of the first reforming microchannel reactor 21 and the second reforming microchannel reactor 22 is provided with a first reforming reaction feed port 207, a second reforming reaction feed port 208, a reforming reaction discharge port 209, a coolant feed port 210, a coolant discharge port 211, a catalytic combustion reaction feed port 212, and a catalytic combustion reaction discharge port 213. The reforming reaction discharge port 209 of the first reforming microchannel reactor 21 is connected to the reforming reaction feed port 208 of the second reforming microchannel reactor 22, and a one-way valve 214 is provided on the connecting pipeline. The coolant feed port 210 of the first reforming microchannel reactor 21 is connected to the coolant discharge port 211 of the second reforming microchannel reactor 22, and the catalytic combustion reaction feed port 212 of the first reforming microchannel reactor 21 is connected to the catalytic combustion reaction discharge port 213 of the second reforming microchannel reactor 22.

A thermal insulation layer 2012 is provided within the housing 201.

The coolant within the heat exchange chamber 205 is a KCl—MgCl₂ molten salt.

Each of the first reforming reaction feed port 207, the second reforming reaction feed port 208, and the reforming reaction discharge port 209 is provided with a temperature detector (such as a thermocouple-type temperature detector) for detecting the temperature of the fluid entering and leaving the reforming reaction chamber, which facilitates the evaluation of the temperature within the reforming reaction chamber.

The coolant feed port 210 and the coolant discharge port 211 are externally connected to a temperature and flow control device 23 to regulate the flow of the coolant in the heat exchange chamber 205, thereby regulating the temperature of the reforming reaction chamber.

The unit for supplying materials to be reformed comprises a desulfurizer 41, of which the inlet is connected to the source of the material to be reformed. The deionized water supply unit comprises a water pump 51, of which the inlet is connected to the source of deionized water. The air supply unit comprises an air compressor 61, of which the inlet is connected to the source of air.

The heat exchange unit comprises a first heat exchanger 31, a second heat exchanger 32, a third heat exchanger 33, a fourth heat exchanger 34, a fifth heat exchanger 35 and a sixth heat exchanger 36;
wherein the first fluid inlet of the first heat exchanger 31 is connected to the outlet of the desulfurizer 41, the first fluid outlet of the first heat exchanger 31 is connected to the first fluid inlet of the fourth heat exchanger 34, and the first fluid outlet of the fourth heat exchanger 34 is connected to the first reforming reaction feed port 207 of the first reforming microchannel reactor 21; the first fluid inlet of the second heat exchanger 32 is connected to the outlet of the water pump 51, and the first fluid outlet of the second heat exchanger 32 is connected to the second reforming reaction feed port 208 of the first reforming microchannel reactor 21; the first fluid inlet of the third heat exchanger 33 is connected to the outlet of the air compressor 61, the first fluid outlet of the third heat exchanger 33 is connected to the first fluid inlet of the fifth heat exchanger 35, and the first fluid outlet of the fifth heat exchanger 35 is connected to the cathode gas inlet of the solid oxide fuel cell 1; the first fluid inlet of the sixth heat exchanger 36 is connected to the outlet of the fuel supply unit, and the first fluid outlet of the sixth heat exchanger 36 is connected to the catalytic combustion reaction feed port 212 of the second reforming microchannel reactor 22; the second fluid inlet of the third heat exchanger 33 is connected to the anode end outlet of the solid oxide fuel cell 1, the second fluid outlet of the third heat exchanger 33 is connected to the second fluid inlet of the second heat exchanger 32, and the second fluid outlet of the second heat exchanger 32 is connected to the second fluid inlet of the first heat exchanger 31; the catalytic combustion reaction discharge port 213 of the first reforming microchannel reactor 21 is connected to the second fluid inlet of the fourth heat exchanger 34, the second fluid outlet of the fourth heat exchanger 34 is connected to a second fluid inlet of the sixth heat exchanger 36, and the cathode end outlet of the solid oxide fuel cell 1 is connected to the second fluid inlet of the fifth heat exchanger 35; the second fluid outlet of the first heat exchanger 31 is connected to the second fluid inlet of the sixth heat exchanger 36; a gas-water separator 7 is provided on a connecting pipeline between the second fluid outlet of the first heat exchanger 31 and the second fluid inlet of the sixth heat exchanger 36 to remove water in the fluid; the second fluid outlet of the first heat exchanger 31 is connected to the catalytic combustion reaction feed port 212 of the second reforming microchannel reactor 22.

### Experimental Example 1

The solid oxide fuel cell-containing power generation system provided in Example 1 is used for power generation, wherein Refinery A feed gas, Refinery B feed gas, and Refinery C feed gas described in Table 1 are used as the materials to be reformed. According to the characteristics of the Refinery A feed gas, the Refinery B feed gas, and the Refinery C feed gas, the first reforming microchannel reactor 21 is closed by controlling the one-way valve 214 between the first reforming microchannel reactor 21 and the second reforming microchannel reactor 22 to operate the second reforming microchannel reactor 22, so that the feed gases are reformed in the microchannel reactor to produce syngas and then enter the solid oxide fuel cell 1 for power generation.

The anode feed gas enters the solid oxide fuel cell 1 under a pressure controlled at 200-300 kpa, in a flow rate controlled at 60 Nm³/h, and at a temperature of 25° C. The cathode feed gas enters the solid oxide fuel cell 1 under a pressure controlled at 200-300 kpa, at a flow rate controlled at 600 Nm³/h, and at a temperature of 25° C. The fuel cell system is operated at a power of 100 kW. The fuel required for the catalytic combustion reaction is SOFC anode tail gas.

The simulation results after COMSOL and Aspen are shown in Table 2. Two system operation times were selected for characterization. When the system was operated for 1 hour, the flow rate at the inlet and outlet of the microreactor remained unchanged; and when the system is operated for a long term of 1000 hours, the flow rate at the outlet of the microreactor remained substantially unchanged, and the attenuation rate was about 0.03%, which confirmed that the microreactor still remained in normal operation during the long-cycle operation. Under the conditions in this example, the power generation efficiency of the system is about 51.45%.

TABLE 1

| | H₂ | CH₄ | C₂H₄ | C₂H₆ | C₃H₈ | C₃H₆ | C₄₊ |
|---|---|---|---|---|---|---|---|
| Types | content | content | content | content | content | content | content |
| Refinery A | 0.1 | 92.5 | 0 | 6.3 | 0.5 | 0 | 0.6 |
| Refinery B | 0.1 | 91.5 | 0 | 5.8 | 0.5 | 0 | 0.2 |
| Refinery C | 0 | 97.5 | 0 | 0 | 0 | 0 | 0 |

TABLE 2
Simulation results from Example 1

| No. | Items | Data |
|---|---|---|
| 1 | Microreactor inlet flow rate after system | 60 m³/h |
| | operation for 1 hour | |
| 2 | Microreactor outlet flow rate after system | 60 m³/h |
| | operation for 1 hour at initial conditions | |
| 3 | Microreactor inlet flow rate after system | 60 m³/h |
| | operation for 1000 hours | |
| 4 | Microreactor outlet flow rate after system | 59.98 m³/h |
| | operation for 1000 hours based on Refinery | |
| | A feed gas | |
| 5 | Microreactor outlet flow rate after system | 59.99 m³/h |
| | operation for 1000 hours based on Refinery | |
| | B feed gas | |
| 6 | Microreactor outlet flow rate after system | 60 m³/h |
| | operation for 1000 hours based on Refinery | |
| | C feed gas | |
| 7 | Power generation efficiency of the system | 51.45% |
| | based on Refinery A feed gas | |
| 8 | Power generation efficiency of the system | 51.22% |
| | based on Refinery B feed gas | |
| 9 | Power generation efficiency of the system | 51.13% |
| | based on Refinery C feed gas | |

### Experimental Example 2

The solid oxide fuel cell-containing power generation system provided in Example 1 is used for power generation, wherein Refinery D feed gas, Refinery E feed gas, and Refinery F feed gas described in Table 3 are used as the materials to be reformed. According to the characteristics of the Refinery D feed gas, the Refinery E feed gas, and the Refinery F feed gas, the first reforming microchannel reactor 21 and the second reforming microchannel reactor 22 are operated in parallel by controlling the one-way valve 214 between the first reforming microchannel reactor 21 and the second reforming microchannel reactor 22, and the feed gases are reformed in the microchannel reactor to produce syngas and then enter the solid oxide fuel cell 1 for power generation. Simultaneously, the temperatures of the first reforming microchannel reactor 21 and second reforming microchannel reactor 22 are regulated by the temperature and flow control device 23 to allow them to be operated within their respective optimal operating ranges.

The anode feed gas enters the solid oxide fuel cell 1 under a pressure controlled at 200-300 kpa, in a flow rate controlled at 60 Nm³/h, and at a temperature of 25° C. The cathode feed gas enters the solid oxide fuel cell 1 under a pressure controlled at 200-300 kpa, at a flow rate controlled at 600 Nm³/h, and at a temperature of 25° C. The fuel cell system is operated at a power of 100 kW. The fuel required for the catalytic combustion reaction is SOFC anode tail gas.

The simulation results after COMSOL and Aspen are shown in Table 4. Two system operation times were selected for characterization. When the system was operated for 1 hour, the flow rate at the inlet and outlet of the microreactor remained unchanged; and when the system is operated for a long term of 1000 hours, the flow rate at the outlet of the microreactor remained substantially unchanged, and the attenuation rate was about 0.8%, which confirmed that the microreactor still remained in normal operation during the long-cycle operation. Under the conditions in this example, the power generation efficiency of the system is about 52.33%.

TABLE 3

| | H₂ | CH₄ | C₂H₄ | C₂H₆ | C₃H₈ | C₃H₆ | C₄₊ |
|---|---|---|---|---|---|---|---|
| Name | content | content | content | content | content | content | content |
| Refinery D | 19.55 | 36.51 | 3.28 | 14.9 | 1.99 | 1.99 | 1.77 |
| Refinery E | 65.37 | 12.56 | 0 | 3.86 | 8.57 | 0 | 9.64 |
| Refinery F | 23.05 | 37.54 | 2.92 | 20.38 | 8.12 | 5.04 | 2.95 |

TABLE 4
Simulation results from Example 2

| No. | Items | Data |
|---|---|---|
| 1 | Microreactor inlet flow rate after system | 60 m³/h |
| | operation for 1 hour | |
| 2 | Microreactor outlet flow rate after system | 60 m³/h |
| | operation for 1 hour at initial conditions | |
| 3 | Microreactor inlet flow rate after system | 60 m³/h |
| | operation for 1000 hours | |
| 4 | Microreactor outlet flow rate after system | 59.53 m³/h |
| | operation for 1000 hours based on | |
| | Refinery D feed gas | |
| 5 | Microreactor outlet flow rate after system | 59.20 m³/h |
| | operation for 1000 hours based on | |
| | Refinery E feed gas | |
| 6 | Microreactor outlet flow rate after system | 58.93 m³/h |
| | operation for 1000 hours based on | |
| | Refinery F feed gas | |
| 7 | Power generation efficiency of the system | 52.33% |
| | based on Refinery D feed gas | |
| 8 | Power generation efficiency of the system | 52.16% |
| | based on Refinery E feed gas | |
| 9 | Power generation efficiency of the system | 53.31% |
| | based on Refinery F feed gas | |

### Experimental Example 3

The solid oxide fuel cell power generation system provided in Example 1 is used for power generation, wherein the material to be reformed is hydrogen, and the first reforming microchannel reactor 21 and the second reforming microchannel reactor 22 are closed, so that the hydrogen directly enters the solid oxide fuel cell 1 for power generation after being heated by the heat exchanger.

The anode feed gas enters the solid oxide fuel cell 1 under a pressure controlled at 200-300 kpa, in a flow rate controlled at 60 Nm³/h, and at a temperature of 25° C. The cathode feed gas enters the solid oxide fuel cell 1 under a pressure controlled at 200-300 kpa, at a flow rate controlled at 600 Nm³/h, and at a temperature of 25° C. The fuel cell system is operated at a power of 100 kW. The fuel required for the catalytic combustion reaction is SOFC anode tail gas.

The simulation results after COMSOL and Aspen are shown in Table 5. Since no microreactor is used to reform reaction gas, no reference value is provided. Under the conditions in this example, the power generation efficiency of the system is about 49.82%.

TABLE 5
Simulation results from Example 3

| No. | Items | Data |
|---|---|---|
| 1 | Microreactor inlet flow rate after system operation | / |
| | for 1 hour | |
| 2 | Microreactor outlet flow rate after system | / |
| | operation for 1 hour at initial conditions | |
| 3 | Microreactor inlet flow rate after system operation | / |
| | for 1000 hours | |
| 4 | Microreactor outlet flow rate after system | / |
| | operation for 1000 hours | |
| 5 | Power generation efficiency of the system | 49.82% |

### Comparative Example 1

This comparative example provides a solid oxide fuel cell-containing power generation system, which differs from the solid oxide fuel cell-containing power generation system provided in Example 1 only in that, the heat exchange chamber 205 is not provided (i.e., the combustion chamber 204 is adjacent to the reforming reaction chamber 206).

The solid oxide fuel cell-containing power generation system provided in this comparative example is used to generate power in the same manner as in Experimental Example 1.

The results are shown in Table 6. The solid oxide fuel cell-containing power generation system provided in this comparative example is used for power generation, and the system power generation efficiency and the outlet flow rate are significantly reduced after a long time of operation. This is mainly because that the temperature of the reforming reaction chamber cannot be effectively controlled without the heat exchange chamber, so that the catalyst functions under high temperature conditions, and the pre-reforming and reforming reaction effects are poor, which in turn leads to the degradation of the catalytic efficiency and the blockage of the microreactor.

TABLE 6

| No. | Items | Data |
|---|---|---|
| 1 | Microreactor inlet flow rate after system | 60 m³/h |
| | operation for 1 hour | |
| 2 | Microreactor outlet flow rate after system | 59.7 m³/h |
| | operation for 1 hour at initial conditions | |
| 3 | Microreactor inlet flow rate after system | 60 m³/h |
| | operation for 1000 hours | |
| 4 | Microreactor outlet flow rate after system | 55.28 m³/h |
| | operation for 1000 hours based on Refinery | |
| | A feed gas | |
| 5 | Microreactor outlet flow rate after system | 54.34 m³/h |
| | operation for 1000 hours based on Refinery | |
| | B feed gas | |
| 6 | Microreactor outlet flow rate after system | 56.15 m³/h |
| | operation for 1000 hours based on Refinery | |
| | C feed gas | |
| 7 | Power generation efficiency of the system | 47.33% |
| | based on Refinery A feed gas | |
| 8 | Power generation efficiency of the system | 48.23% |
| | based on Refinery B feed gas | |
| 9 | Power generation efficiency of the system | 45.16% |
| | based on Refinery C feed gas | |

### Comparative Example 2

This comparative example provides a solid oxide fuel cell-containing power generation system, which is different from the solid oxide fuel cell-containing power generation system provided in Example 1 only in that, the combustion catalyst layer of the first plate 202 coated on the ceramic-metal composite substrate is formed with non-monoatomic metal-based catalyst, and the reforming catalyst layer of the second plate 203 coated on the ceramic-metal composite substrate is formed with a non-monoatomic metal-based catalyst. For the sake of simplicity in modeling, the selected non-monoatomic metal-based catalysts comprise spherical particles of approximately 20 nm in size.

The solid oxide fuel cell-containing power generation system provided in this comparative example is used to generate power in the same manner as in Experimental Example 1.

The results are shown in Table 7. The solid oxide fuel cell-containing power generation system provided in this comparative example is used for power generation, and the system power generation efficiency and the outlet flow rate are significantly reduced after a long time of operation. This is because that the non-monoatomic catalyst itself has poor resistance to carbon deposition, which causes agglomeration and blocking of microchannels under high temperature conditions.

TABLE 7

| No. | Items | Data |
|---|---|---|
| 1 | Microreactor inlet flow rate after system | 60 m³/h |
| | operation for 1 hour | |
| 2 | Microreactor outlet flow rate after system | 59.7 m³/h |
| | operation for 1 hour at initial conditions | |
| 3 | Microreactor inlet flow rate after system | 60 m³/h |
| | operation for 1000 hours | |
| 4 | Microreactor outlet flow rate after system | 35.42 m³/h |
| | operation for 1000 hours based on Refinery | |
| | A feed gas | |
| 5 | Microreactor outlet flow rate after system | 34.39 m³/h |
| | operation for 1000 hours based on Refinery | |
| | B feed gas | |
| 6 | Microreactor outlet flow rate after system | 36.11 m³/h |
| | operation for 1000 hours based on Refinery | |
| | C feed gas | |
| 7 | Power generation efficiency of the system | 31.36% |
| | based on Refinery A feed gas | |
| 8 | Power generation efficiency of the system | 33.21% |
| | based on Refinery B feed gas | |
| 9 | Power generation efficiency of the system | 32.13% |
| | based on Refinery C feed gas | |

The above are only preferred embodiments of the present disclosure and are not intended to limit the present disclosure, and any modifications, equivalent substitutions, improvements and the like made within the spirit and principle of the present disclosure should be comprised in the protection scope of the present disclosure.

1. A reforming microchannel reactor comprising:
a housing,
a plurality of plates arranged within the housing, and
at least one combustion chamber, at least one heat exchange chamber, and at least one reforming reaction chamber separated by the plates within the housing;
wherein the combustion chamber, the heat exchange chamber and the reforming reaction chamber are arranged alternately, and each heat exchange chamber is provided between a combustion chamber and a reforming reaction chamber;
wherein the plurality of plates comprise a first plate and a second plate;
the combustion chamber and the heat exchange chamber are separated by the first plate, and the heat exchange chamber and the reforming reaction chamber are separated by the second plate;
the first plate comprises a ceramic-metal composite substrate and a combustion catalyst layer supported on at least one surface of the ceramic-metal composite substrate, and the combustion catalyst layer is located on the side facing the combustion chamber, wherein the combustion catalyst in the combustion catalyst layer is a monoatomic metal-based catalyst; and
the second plate comprises a ceramic-metal composite substrate and a reforming catalyst layer supported on at least one surface of the ceramic-metal composite substrate, and the reforming catalyst layer is located on the side facing the reforming reaction chamber, wherein the reforming catalyst in the reforming catalyst layer is a monoatomic metal-based catalyst.

2. The reforming microchannel reactor according to claim 1, wherein,
within the housing, when a combustion chamber serves as the outermost chamber adjacent to the housing, a first plate is provided between the combustion chamber and the housing, wherein the combustion catalyst layer is located on the side facing the combustion chamber; and
within the housing, when a reforming reaction chamber serves as the outermost chamber adjacent to the housing, a second plate is provided between the reforming reaction chamber and the housing, wherein the reforming catalyst layer is located on the side facing the reforming reaction chamber.

3. The reforming microchannel reactor according to claim 1, wherein the reforming microchannel reactor is a flat plate microchannel reactor, and the combustion chamber, the heat exchange chamber and the reforming reaction chamber are arranged within the housing of the reforming microchannel reactor along the thickness direction of the reforming microchannel reactor.

4. The reforming microchannel reactor according to claim 3, wherein a reforming reaction chamber, a heat exchange chamber, a combustion chamber, a heat exchange chamber, a reforming reaction chamber, a heat exchange chamber, a combustion chamber, a heat exchange chamber, a reforming reaction chamber, a heat exchange chamber, and a combustion chamber are sequentially arranged within the housing of the reforming microchannel reactor along the thickness direction of the reforming microchannel reactor.

5. The reforming microchannel reactor according to claim 3, wherein,
the reforming reaction chamber has a thickness of 10-1000 μm;
the heat exchange chamber has a thickness of 10-1000 μm; and
the combustion chamber has a thickness of 10-1000 μm.

6. The reforming microchannel reactor according to claim 3, wherein,
the reforming microchannel reactor is operated in a T-shaped, cross-shaped or coaxial ring-tube feeding mode;
the configuration of feed and discharge ports for each chamber of the reforming microchannel reactor enables a single-pass cross-flow movement of fluid through each chamber of the reactor;
the configuration of feed and discharge ports for each chamber of the reforming microchannel reactor enables a cross-shaped cross-flow movement of fluid through each chamber of the reactor.

7. The reforming microchannel reactor according to claim 1, wherein,
the ceramic-metal composite substrate of the first plate is composed of a metal plate core and a ceramic shell laminated on the surface of the metal plate, wherein the metal plate core of the ceramic-metal composite substrate of the first plate has a thickness of not greater than 2 cm, and the ceramic shell laminated on the surface of the metal plate has a thickness of not greater than 50 μm; and
the ceramic-metal composite substrate of the second plate is composed of a metal plate core and a ceramic shell laminated on the surface of the metal plate, wherein the metal plate core of the ceramic-metal composite substrate of the second plate has a thickness of not greater than 2 cm, and the ceramic shell laminated on the surface of the metal plate has a thickness of not greater than 50 μm.

8. The reforming microchannel reactor according to claim 1, wherein the combustion catalyst is a Pt/Al₂O₃ catalyst, and the loading amount of Pt is not greater than 4% based on 100% by mass of Al₂O₃; and
wherein the reforming catalyst is a Rh/Al₂O₃ catalyst, and the loading amount of Rh is not greater than 4% based on 100% by mass of Al₂O₃.

9. The reforming microchannel reactor according to claim 1, wherein the first plate can be prepared by:
spraying alumina onto a metal plate by thermal spraying to form a ceramic-metal composite substrate; pretreating the ceramic-metal composite substrate by a process including cutting, cleaning and ultrasonic treatment; and coating the surface of the pretreated ceramic-metal composite substrate with alumina sol to obtain a first substrate;
weighing and mixing an amount of an active metal precursor salt corresponding to the combustion catalyst, an organic ligand and an organic solvent to obtain a first solution; and
impregnating at least one surface of the first substrate with the first solution, drying and roasting under a protective atmosphere to obtain the first plate.

10. The reforming microchannel reactor according to claim 9, wherein,
the active metal precursor salt comprises one or more of a nitrate, sulfate, chloride and acetate of the active metal;
the organic ligand comprises at least one of phenanthroline, 2,2-bipyridine, melamine and phenylalanine; and
the organic solvent comprises at least one of dimethyl sulfoxide and ethanol.

11. The reforming microchannel reactor according to claim 9, wherein,
in the first solution, the molar ratio of the active metal precursor salt to the organic ligand is 1:5-1:20;
in the first solution, based on the total volume of the first solution, the molar concentration of the active metal precursor salt is not greater than 0.2 mol·L⁻¹; and
in the first solution, based on the total volume of the first solution, the molar concentration of the organic ligand is not greater than 4 mol·L⁻¹.

12. The reforming microchannel reactor according to claim 1, wherein the second plate can be prepared by:
spraying alumina onto a metal plate by thermal spraying to form a ceramic-metal composite substrate; pretreating the ceramic-metal composite substrate by a process including cutting, cleaning, and ultrasonic treatment; and coating the surface of the pretreated ceramic-metal composite substrate with alumina sol to obtain a second substrate;
weighing and mixing an amount of an active metal precursor salt corresponding to the combustion catalyst, an organic ligand and an organic solvent to obtain a second solution; and
impregnating at least one surface of the second substrate with the second solution, drying and roasting under a protective atmosphere to obtain the second plate.

13. The reforming microchannel reactor according to claim 12, wherein,
the active metal precursor salt comprises one or more of a nitrate, sulfate, chloride and acetate of the active metal;
the organic ligand comprises at least one of phenanthroline, 2,2-bipyridine, melamine and phenylalanine; and
the organic solvent comprises at least one of dimethyl sulfoxide and ethanol.

14. The reforming microchannel reactor according to claim 12, wherein,
in the second solution, the molar ratio of the active metal precursor salt to the organic ligand is 1:5-1:20;
in the second solution, based on the total volume of the second solution, the molar concentration of the active metal precursor salt is not greater than 0.2 mol·L⁻¹;
in the second solution, based on the total volume of the second solution, the molar concentration of the organic ligand is not greater than 4 mol·L⁻¹.

15. The reforming microchannel reactor according to claim 1, further comprising a coolant located within the heat exchange chamber,
wherein the coolant is a molten salt selected from LiF—NaF—KF, KCl—MgCl₂ and NaNO₃—NaNO₂—KNO₃.

16. A solid oxide fuel cell-containing power generation system, comprising:
a unit for supplying materials to be reformed, a deionized water supply unit, an air supply unit, a fuel supply unit, a microchannel reactor unit for reforming and producing syngas, and a solid oxide fuel cell, wherein the microchannel reactor unit for reforming and producing syngas comprises at least one reforming microchannel reactor according to claim 1,
wherein the unit for supplying materials to be reformed, the deionized water supply unit, the air supply unit, the fuel supply unit, the microchannel reactor unit for reforming and producing syngas and the solid oxide fuel cell are connected to enable the unit for supplying materials to be reformed to supply the materials to be reformed required for the reforming reaction to the microchannel reactor unit for reforming and producing syngas, enable the deionized water supply unit to supply the steam required for the reforming reaction to the microchannel reactor unit for reforming and producing syngas, enable the fuel supply unit to supply the fuel required for the catalytic combustion reaction to the microchannel reactor unit for reforming and producing syngas, enable the air supply unit to supply air to the cathode of the solid oxide fuel cell, and enable the syngas produced by the reforming reaction in the microchannel reactor unit for reforming and producing syngas to be supplied to the anode of the solid oxide fuel cell.

17. The solid oxide fuel cell-containing power generation system according to claim 16, further comprising: a heat exchange unit comprising a first heat exchanger, a second heat exchanger, a third heat exchanger, a fourth heat exchanger, a fifth heat exchanger and a sixth heat exchanger,
wherein the first fluid inlet of the first heat exchanger is connected to the outlet of the unit for supplying materials to be reformed, the first fluid outlet of the first heat exchanger is connected to the first fluid inlet of the fourth heat exchanger, and the first fluid outlet of the fourth heat exchanger is connected to the reforming reaction feed port of the microchannel reactor unit for reforming and producing syngas;
the first fluid inlet of the second heat exchanger is connected to the outlet of the deionized water supply unit, and the first fluid outlet of the second heat exchanger is connected to the reforming reaction feed port of the microchannel reactor unit for reforming and producing syngas;
the first fluid inlet of the third heat exchanger is connected to the outlet of the air supply unit, the first fluid outlet of the third heat exchanger is connected to the first fluid inlet of the fifth heat exchanger, and the first fluid outlet of the fifth heat exchanger is connected to the cathode gas inlet of the solid oxide fuel cell;
the first fluid inlet of the sixth heat exchanger is connected with the outlet of the fuel supply unit, and the first fluid outlet of the sixth heat exchanger is connected with the catalytic combustion reaction feed port of the microchannel reactor unit for reforming and producing syngas;
the second fluid inlet of the third heat exchanger is connected to the anode end outlet of the solid oxide fuel cell, the second fluid outlet of the third heat exchanger is connected to the second fluid inlet of the second heat exchanger, and the second fluid outlet of the second heat exchanger is connected to the second fluid inlet of the first heat exchanger;
the catalytic combustion reaction discharge port of the microchannel reactor unit for reforming and producing syngas is connected to the second fluid inlet of the fourth heat exchanger, the second fluid outlet of the fourth heat exchanger is connected to the second fluid inlet of the sixth heat exchanger, and the cathode end outlet of the solid oxide fuel cell is connected to the second fluid inlet of the fifth heat exchanger.

18. The solid oxide fuel cell-containing power generation system according to claim 17, wherein,
the second fluid outlet of the first heat exchanger is connected to the second fluid inlet of the sixth heat exchanger; and
the second fluid outlet of the first heat exchanger is connected to the catalytic combustion reaction feed port of the microchannel reactor unit for reforming and producing syngas.

19. The solid oxide fuel cell-containing power generation system according to claim 16, wherein the microchannel reactor unit for reforming and producing syngas comprises at least two reforming microchannel reactors, which are sequentially connected in series,
wherein the reforming reaction discharge port of the i-th reforming microchannel reactor is connected to the reforming reaction feed port of the (i+1)-th reforming microchannel reactor;
the coolant feed port of the i-th reforming microchannel reactor is connected to the coolant discharge port of the (i+1)-th reforming microchannel reactor;
the catalytic combustion reaction feed port of the i-th reforming microchannel reactor is connected to the catalytic combustion reaction discharge port of the (i+1)-th reforming microchannel reactor;
the catalytic combustion reaction discharge port of the first reforming microchannel reactor serves as the catalytic combustion reaction discharge port of the microchannel reactor unit for reforming and producing syngas;
the catalytic combustion reaction feed port of the last reforming microchannel reactor serves as the catalytic combustion reaction feed port of the microchannel reactor unit for reforming and producing syngas;
the reforming reaction discharge port of the last reforming microchannel reactor serves as the reforming reaction discharge port of the microchannel reactor unit for reforming and producing syngas;
the reforming reaction feed port of the first reforming microchannel reactor serves as the reforming reaction feed port of the microchannel reactor unit for reforming and producing syngas;
the coolant discharge port of the first reforming microchannel reactor serves as the coolant discharge port of the microchannel reactor unit for reforming and producing syngas; and
the coolant discharge port of the last reforming microchannel reactor serves as the coolant discharge port of the microchannel reactor unit for reforming and producing syngas.

20. The solid oxide fuel cell-containing power generation system according to claim 16, wherein,
the unit for supplying materials to be reformed comprises a desulfurizer, wherein the inlet of the desulfurizer is connected to a source of the material to be reformed, and the outlet of the desulfurizer serves as the outlet of the unit for supplying materials to be reformed;
the deionized water supply unit comprises a water pump, wherein the inlet of the water pump is connected to a source of deionized water, and the outlet of the water pump serves as the outlet of the deionized water supply unit; and
the air supply unit comprises an air compressor, wherein the inlet of the air compressor is connected to a source of air, and the outlet of the air compressor serves as the outlet of the air supply unit.
